(19) United States
(12) Patent Application Publication
(10) Pub. No.: US 2024/0305458 A1
(43) Pub. Date: Sep. 12, 2024

(54) Systems and Methods for Non-Custodial Key Storage and Digital Signatures

(71) Applicant: Realio Technology, LTD, New York, NY (US)

(72) Inventors: Derek Boirun, New York, NY (US); Eduardo Romeiro, Boston, MA (US)

(21) Appl. No.: 18/179,964

(22) Filed: Mar. 7, 2023

(51) Int. Cl. H04L 9/08; H04L 9/30; H04L 9/32

(52) U.S. Cl. CPC H04L 9/0894; H04L 9/0869; H04L 9/3073; H04L 9/3247

(57) ABSTRACT

In some aspects, the disclosure is directed to methods and systems for non-custodial key generation and storage in which, other than for brief periods during key generation, when digitally signing data, or when decrypting encrypted data, a user's private key is not stored in an unencrypted form, either on the user's device or external or network storage. In some implementations, the private key is stored encrypted by a cipher that similarly relies on a secret that is not stored on either the user's device or any network location.

### FIELD OF THE DISCLOSURE

This disclosure generally relates to systems and methods for computer security. In particular, this disclosure relates to systems and methods for non-custodial key storage and digital signatures.

### BACKGROUND OF THE DISCLOSURE

Asymmetric cryptography or public-key cryptography relies on a public key, which may be freely distributed, and a private key, that must be securely retained. Asymmetric cryptography has many uses, including in ensuring confidentiality of messages or digitally signing transactions or data to verify its authenticity or provenance. For example, cryptocurrency wallets or blockchains typically use asymmetric cryptography with public keys as addresses and private keys used to sign transactions between wallets.

Private keys, which may be long and complex strings of alphanumeric characters, are typically difficult to remember. As a result, many users store their private keys on their computing devices, such as a mobile phone, laptop, or desktop computer, or in storage devices such as portable flash drives. Loss or damage of, or malicious access to, these devices may result in the user unable to access their encrypted data, unable to authenticate signed transactions or data, or otherwise compromise security. Some attempts to avoid this include storing private keys at servers of a third-party, but this simply shifts the risk to their security efforts and requires a significant amount of trust, which may not be appropriate in many cases.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1A is a block diagram of an implementation of a system for non-custodial key generation and storage;

FIG. 1B is a block diagram of an implementation of a system for non-custodial key retrieval;

FIG. 2A is a flow chart of an implementation of a method of non-custodial key generation and storage;

FIG. 2B is a flow chart of an implementation of a method of non-custodial key retrieval; and

FIG. 3 is a block diagram of an implementation of a system for digitally signing data using a non-custodial key;

FIG. 4 is a flow chart of an implementation of a method of digitally signing data using a non-custodial key; and

FIGS. 5A and 5B are block diagrams depicting embodiments of computing devices useful in connection with the methods and systems described herein.

The details of various embodiments of the methods and systems are set forth in the accompanying drawings and the description below.

### DETAILED DESCRIPTION

For purposes of reading the description of the various embodiments below, the following descriptions of the sections of the specification and their respective contents may be helpful:
Section A describes embodiments of systems and methods for non-custodial key storage and digital signatures; and
Section B describes a computing environment which may be useful for practicing embodiments described herein.

### A. Systems and Methods for Non-Custodial Key Storage and Digital Signatures

A significant weakness of asymmetric cryptography is the risk that a private key of a cryptographic key pair becomes unavailable to its authorized user or becomes known. With the former, the user may be unable to authenticate transactions or access encrypted data. With the latter, a malicious attacker may be able to impersonate the user and access systems without authorization, including data storage systems, banking or cryptocurrency systems, or other critical infrastructure.

Some efforts to secure private keys include storage of the private key on a dedicated hardware storage device, such as a USB flash drive with hardware encryption, or backup of private keys in online storage provided by a third party. However, such efforts are still vulnerable to loss or damage or malicious actors.

Instead, implementations of the systems and methods discussed herein provide for non-custodial key generation and storage in which, other than for brief periods during key generation, when digitally signing data, or when decrypting encrypted data, the user's private key is not stored in an unencrypted form, either on the user's device or external or network storage. Instead, the private key is stored encrypted by a cipher that similarly relies on a secret that is not stored on either the user's device or any network location. As a result, the user need not be concerned about loss of their personal device or hardware key wallet, or that malicious attackers may access a third-party data store and obtain the unencrypted private key.

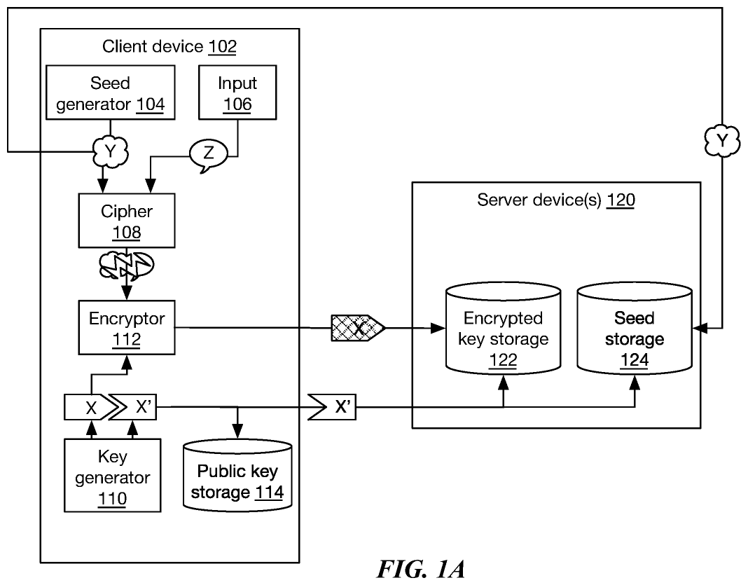

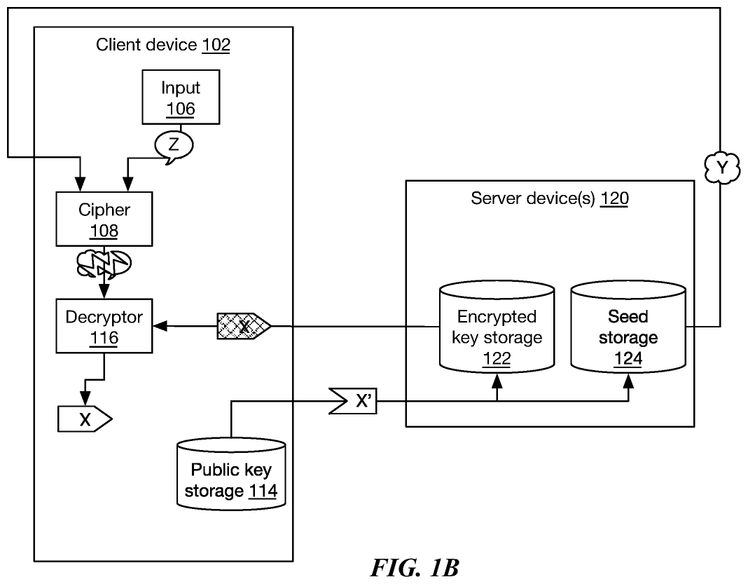

FIG. 1A is a block diagram of an implementation of a system for non-custodial key generation and storage. A client device 102, which may comprise a laptop computing device, desktop computing device, tablet computing device, smartphone, wearable device, smart appliance including a smart car or home automation system, set top box, video game console, or any other type and form of computing device, may operate on behalf of a user to generate and encrypt a private key of a cryptographic key pair. In some implementations, a client device 102 may communicate with other client devices or one or more server devices 120 via one or more networks (not illustrated). As discussed in more detail below, a client device 102 may comprise one or more processor devices; one or more memory devices including RAM, data storage such as flash memory or hard drives, or other memory; one or more network interfaces such as cellular interfaces, wireless interfaces (e.g. 802.11 or WiFi interfaces, Bluetooth interfaces, near-field communication (NFC) interfaces, or other interfaces), wired interfaces (e.g. Ethernet, coaxial data, serial or parallel data buses, or other such interfaces), or a combination of these or other interfaces; and one or more input and/or output devices, such as a mouse, keyboard, monitor, speakers, touch-screen or multi-touch monitor or display, a joystick, a gamepad, stereoscopic displays (e.g. augmented reality or virtual reality displays), or any other type and form of input and/or output devices.

In some implementations, the client device 102 may comprise a seed generator 104, which may be embodied in hardware, software, or a combination of hardware and software. Seed generator 104 may comprise an application, service, server, daemon, routine, or other executable logic for generating random numbers or pseudo-random numbers, sometimes referred to generally as cryptographic “seeds” or seed values. For example, in some implementations, seed generator 104 may comprise a hardware cryptographic processor including a random number generator. In other implementations, seed generator 104 may comprise a pseudo-random number generation algorithm executed by a processor of client device 102. Seed generator 104 may be used to generate a seed value, such as a randomized string of binary data, hexadecimal data, alphanumeric data, or other data, and with any appropriate length or resolution (e.g. a random floating point value between 0 and 1, a random 32-bit or 64-bit word, or any other such randomized value). In the illustration of FIG. 1A, the seed value is represented by the symbol “Y”. In some implementations, discussed in more detail below, the seed value may be transmitted for storage to a server device or devices 120.

As discussed above, client device 102 may comprise an input device 106, such as a keyboard, microphone, mouse, touchscreen, or other input interface for receiving data from a user. In some implementations, a user may input an identifier, represented by the symbol “Z” in FIG. 1A. The user identifier may comprise a password or passphrase; an alphanumeric string; user biometric data such as a fingerprint, voice print, retinal scan, or facial scan; or any other such information. In many implementations, the user identifier may not be stored by the client device 102 (or any other devices) after key generation. For example, the user identifier may comprise a passphrase to be provided by the user to generate or retrieve a private key or to digitally sign data or transactions. In some implementations, input device 106 may be used to provide additional entropy for or a source of random data to seed generator 104.

Client device 102 may comprise a cipher algorithm 108, which may be embodied in hardware, software, or a combination of hardware and software. For example, in some implementations, cipher 108 may be embodied in a cryptographic application-specific integrated circuit (ASIC) or field programmable gate array (FPGA), while in other implementations, cipher 108 may be embodied in software or executable logic executed by a processor of the client device 102. In some implementations, a seed value Y and user identifier Z may be enciphered to generate a cipher value (represented as a modified Y/Z symbol in FIG. 1A). For example, in some implementations, the seed value and user identifier may be concatenated, bitwise XOR'd, or otherwise combined to generate an input value to cipher 108 (sometimes referred to as a plaintext value, though it may not be human readable in many instances). The input value may be enciphered via any appropriate cipher algorithm, such as the 256-bit key Advanced Encryption Standard algorithm (AES-256), the Data Encryption Standard algorithm (DES), the Blowfish or Twofish cipher algorithms, or any other such algorithm. In many implementations, cipher 108 may comprise a symmetric encryption algorithm.

Client device 102 may comprise a key generator 110. Key generator 110 may comprise an application, service, server, daemon, routine, or other executable logic for generating a asymmetric cryptographic key pair. For example, in some implementations, key generator 110 may execute an elliptic curve signature generation algorithm to generate a private key and public key of a cryptographic key pair. In many implementations, key generator 110 may comprise or may communicate with seed generator 104 and/or input device 106 to receive random or pseudo-random numbers (e.g. for use in the key generation algorithm). In the illustration of FIG. 1A, the private key and public key are represented by symbols X and X′ respectively. In many implementations, the public key (X′) may be stored in a local storage device or memory 114 of the client device (e.g. RAM, flash memory, a hard drive, an external storage device such as removable flash memory, encoded into a printable image such as a QR code or bar code, or otherwise retained). In many implementations, the public key may be transmitted to a remote device (e.g. server device(s) 120) for storage, in addition to or instead of local storage.

Client device 102 may comprise an encryptor 112. Encryptor 112 may be embodied in hardware (e.g. as a hardware encryption circuit, co-processor, ASIC, FPGA, etc.) or in software. For example, encryptor 112 may comprise an application, service, server, daemon, routine, or other executable logic for encrypting a private key (X) using the cipher output as an encryption seed. In some implementations, encryptor 112 may use a symmetric encryption algorithm. In some implementations, encryptor 112 may use AES-256, DES, Twofish, or any other type and form of encryption or combination of encryption algorithms (e.g. multiple algorithms performed sequentially). The output of encryptor 112 or the encrypted private key is represented in FIG. 1A as a shaded symbol X. In some implementations, the encrypted private key may be stored in memory of client device 102 or an external storage device. In some implementations, the encrypted private key may be transmitted to another computing device, such as server device(s) 120. After encrypting the private key, in many implementations, the unencrypted or original private key may be deleted or discarded from memory of the client device 102. That is, in many implementations, the unencrypted private key is not stored anywhere after key generation and encryption (at least until the key is recovered, as discussed below).

As discussed above, in some implementations, the client device 102 may communicate with a server device or devices 120. Server device(s) 120 may comprise desktop computing device, rackmount computing devices, server computing devices, workstation computing devices, appliances, blade servers, server farms or clusters, virtual computing devices executing on one or more physical computing devices (e.g. a server cloud) or any other type and form of computing device or devices. In some implementations, server device(s) may comprise storage devices, such as a storage cloud, network storage device, or other such devices.

In some implementations, server device(s) 120 may store and/or maintain an encrypted key storage database 122. In some implementations, server device(s) 120 may store and/or maintain a seed storage database 124. Encrypted key storage database 122 and seed storage database 124 may be the same database or different databases, in various implementations, and may be stored on the same server device(s) or different server devices. Encrypted key storage database 122 may store each encrypted private key (indicated with a shaded X in FIG. 1A) in association with the corresponding public key (indicated as X′ in FIG. 1A). For example, in some implementations, a public key (X′) may be used as an index to the database with the corresponding private key (shaded X) as an associated entry. This may allow for quick retrieval of the encrypted private key. Similarly, in some implementations, seed values (indicated as Y in FIG. 1A) may be stored in seed storage database 124 in association with the corresponding public key (X′). In many such implementations, the public key may be used as an index in the database to the corresponding seed value Y, as discussed above.

Accordingly, after the key generation process is complete, the encrypted private key (shaded X in FIG. 1A) may be stored in association with the corresponding public key (X′), and the seed value (Y) may be stored in association with the corresponding public key (X′). The unencrypted private key (X) and user identifier (Z) (as well as the cipher value, in many implementations) may be discarded and not stored either at a client device 102 or server device 120.

To recover the unencrypted private key, a similar process may be performed. FIG. 1B is a block diagram of an implementation of a system for non-custodial key retrieval. In some implementations, a client device 102 may transmit a public key (shown as X′ in FIG. 1B) to a server device 120. The server device 120 may retrieve the associated encrypted private key (shown as shaded X) and seed value (Y) from databases 122 and/or 124, and may transmit the encrypted private key and seed value to the client device 102. In other implementations in which the seed value and encrypted private key are stored locally on client device 102 or on an external storage device, client device 102 may retrieve the seed value and encrypted private key.

The user may input, via input 106, the user identifier, and client device 102 may encipher the retrieved seed value and input user identifier to regenerate the cipher value. Decryptor 116, which may comprise hardware and/or software for executing a symmetric decryption algorithm corresponding to the encryption algorithm used by encryptor 112, may decrypt the encrypted private key using the cipher value, and output the unencrypted private key (shown as unshaded X in FIG. 1B). The private key may then be utilized as needed (e.g. for decrypting messages, digitally signing transactions or data, or other such uses).

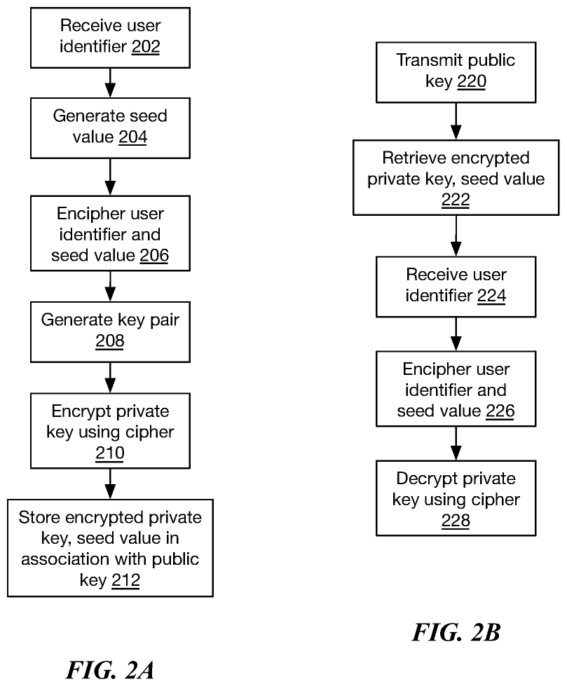

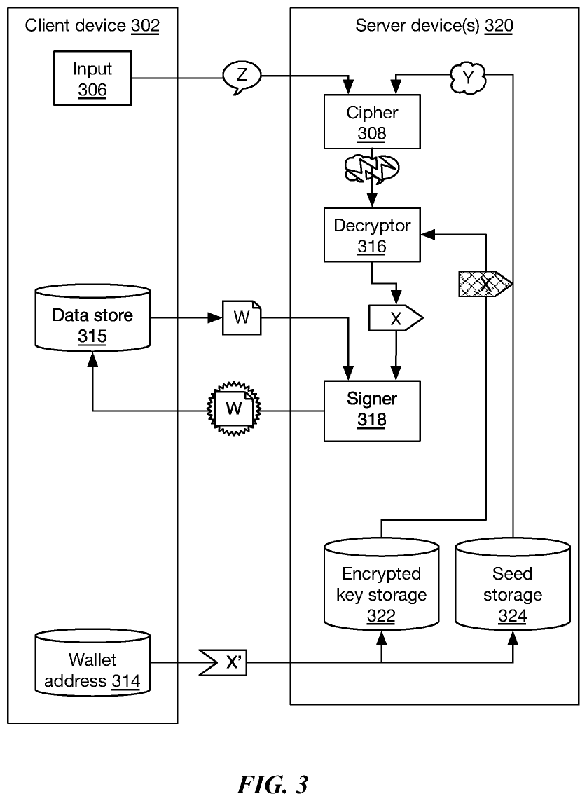

FIG. 2A is a flow chart of an implementation of a method of non-custodial key generation and storage. At step 202, in some implementations, a first computing device may receive a user identifier. The user identifier may be received via an input device, such as a keyboard, camera, or other such input device. In many implementations, the user identifier may comprise a passphrase, a password, an alphanumeric string, a QR code, biometric data, or any other reproducible and secure individual data of a user or combination of such data. In some implementations, receiving the user identifier may include performing a 2-factor authentication algorithm (e.g. verifying that the user is in possession of an associated mobile device), or similar security algorithms.

At step 204, in some implementations, the first computing device may generate a seed value. The seed value may comprise a random or pseudorandom number in many implementations. In some implementations, the seed value may include additional data to add entropy (e.g. timestamps, device identifiers, or any other source of data). In some implementations, step 204 may be performed responsive to receiving the user identifier at step 202.

At step 206, in some implementations, the first computing device may encipher the user identifier and seed value using any appropriate cipher algorithm, such as AES-256, DES, or Twofish. In many implementations, the cipher algorithm may comprise a symmetric encryption algorithm. In some implementations, enciphering the user identifier and seed value may include concatenating the user identifier and seed value, performing a bitwise XOR, or otherwise combining or aggregating the user identifier and seed value. The output of the cipher algorithm may be referred to as a cipher value. In some implementations, the cipher value may be truncated or extended to a predetermined length (e.g. by adding null values, by repeating the cipher output, etc.).

At step 208, in some implementations, the first computing device may generate a cryptographic key pair including a private key and a public key. The cryptographic key pair may be generated via any suitable method or algorithm. In some implementations, generating the key pair may comprise generating a random or pseudorandom number as a first key and calculating a second key via an elliptic curve algorithm or other key generation algorithm. In some implementations, the key pair may be generated by a second computing device or co-processor of the first computing device, and the first computing device may retrieve the private key and public key from the second computing device or co-processor.

At step 210, in some implementations, the first computing device may encrypt the private key of the key pair with the cipher value. For example, in some implementations, the first computing device may encrypt the private key via a symmetric encryption algorithm using the cipher value as a cryptographic seed. In some implementations, the private key and cipher value may be concatenated, XOR'd, or otherwise combined before encryption. Any suitable encryption algorithm may be utilized.

At step 212, in some implementations, the encrypted private key may be stored in association with the unencrypted public key. In some implementations, the seed value may also be stored in association with the unencrypted public key. The encrypted private key and seed value may be stored in a single database or separate databases or other data structures. In some implementations, the public key and the encrypted private key and/or seed value may be transmitted to a second computing device for storage. After the encrypted private key and seed value are stored, in some implementations, the unencrypted private key may be discarded or deleted or purged from memory of the first computing device. In some implementations, the seed value may also be discarded or deleted or purged from memory of the first computing device. In some implementations, the cipher value may also be discarded or deleted or purged from memory of the first computing device. In some implementations, the user identifier may also be discarded or deleted or purged from memory of the first computing device. Accordingly, in many implementations, the unencrypted private key, seed value, user identifier, and/or cipher value may not be stored by the first computing device. In a further implementation, the unencrypted private key and user identifier may not be stored by any other computing device.

Although shown in one order in FIG. 2A, other orders of operations are possible. For example, in some implementations, generating the key pair at step 208 may be performed prior to or after step 202, in parallel with step 204, etc. Transmitting the seed value and public key to a second computing device for storage may be performed prior to encrypting the private key in some implementations.

FIG. 2B is a flow chart of an implementation of a method of non-custodial key retrieval. At step 220 in some implementations, a first computing device may transmit a public key of a user to a second computing device or server computing device. The transmission may be part of a request for an encrypted public key and/or seed value, and may be performed via any suitable means (e.g. via a remote procedure call, an application programming interface, as part of a RESTful request, etc.).

At step 222, in some implementations, the first computing device may retrieve the encrypted private key of the user and the corresponding seed value. Retrieving the encrypted key and seed value may include receiving the encrypted key and seed value as a response to a request transmitted at step 220 in some implementations. For example, the second computing device may use the public key as an index to one or more databases to retrieve associated entries comprising the encrypted private key and seed value, as discussed above. In other implementations in which the encrypted private key of the user and/or seed value are stored locally by the first computing device or on an external storage device, step 220 may be skipped and the encrypted key and/or seed value may be retrieved from memory directly.

At step 224, in some implementations, the first computing device may receive a user identifier via an input device. As discussed above, the user identifier may comprise a passphrase or password, optical code, biometric identifier, or other such identifier. Receiving the user identifier may include performing a 2-factor authentication process in some implementations. Although shown after step 222, in some implementations, step 224 may be performed prior to step 220 and/or step 222 (e.g. transmitting the public key or retrieving the encrypted private key or seed value may be performed responsive to receiving the user identifier).

At step 226, in some implementations, the first computing device may encipher the user identifier and retrieved seed value using any appropriate cipher algorithm, such as AES-256, DES, or Twofish, as discussed above at step 206. In many implementations, the cipher algorithm may comprise a symmetric encryption algorithm. In some implementations, enciphering the user identifier and seed value may include concatenating the user identifier and seed value, performing a bitwise XOR, or otherwise combining or aggregating the user identifier and seed value. The output of the cipher algorithm may be referred to as a cipher value. In some implementations, the cipher value may be truncated or extended to a predetermined length (e.g. by adding null values, by repeating the cipher output, etc.).

At step 228, in some implementations, the first computing device may decrypt the encrypted private key using the cipher value using a decryption algorithm corresponding to the encryption algorithm utilized at step 210 to generate an unencrypted private key. The unencrypted private key may be utilized for any suitable purpose, such as decrypting messages, digitally signing data or transactions, or other such functions. After use, in some implementations, the first computing device may discard the decrypted private key. The first computing device may also discard the user identifier, the seed value, and/or the cipher value in various implementations.

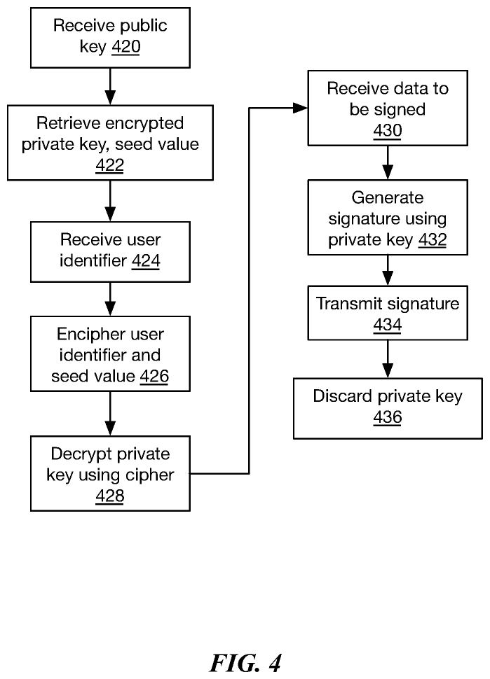

In another aspect, implementations of the systems and methods may be used for digitally signing data or transactions, such as transactions to be recorded to a blockchain or other distributed or centralized ledger. FIG. 3 is a block diagram of an implementation of a system for digitally signing data using a non-custodial key. A client device 302, which may comprise a client device 102 as discussed above, may communicate via a network (not illustrated) with a server device or devices 320 (which may comprise device(s) 120 discussed above). Client device 302 may generate a public key (illustrated as symbol X′ in FIG. 3), encrypted private key (illustrated as shaded symbol X), and seed value (symbol Y) as discussed above, and may provide these for storage in databases 322, 324 of the server devices 320 (similar to databases 122, 124 as discussed above). In many implementations, the public key may be utilized as a cryptocurrency wallet address or public blockchain address.

In some implementations, the initial generation of the public key and private key and/or seed value may instead be performed by server device(s) 320, and the public key may be provided to the client device 302 for storage (e.g. in a wallet address database 314 or similar data structure or memory of the client device or external storage device). In some such implementations, generation of the encrypted private key may be performed by the server device(s) 320 rather than the client device 302, and the user identifier (illustrated as symbol Z in FIG. 3) may be provided to the server device(s) 320 after capture via an input device 306 of client device 302. That is, one or more of the components described in FIG. 1A in connection with the client device 102 may be present in the server device(s) 320 and the method of FIG. 2A may be performed by the server device(s) 320, upon receipt of the user identifier from the client device 302. In many such implementations, the private key may not be transmitted to the client device 302 (and may not be stored in unencrypted form on the server device(s) 320).

To digitally sign data or a transaction (illustrated as symbol W in FIG. 3), the client device 302 may provide the data or transaction to be signed (which may be stored in a data store 315 or other storage device), the user identifier (e.g. symbol Z) and the public key or wallet address (symbol X′) to the server device(s) 320. The server device(s) may retrieve the encrypted private key and seed value from databases 322, 324 using the public key or wallet address. The server device(s) 320 may comprise a cipher algorithm 308, similar to cipher algorithm 108 discussed above, and may generate a cipher value from the user identifier and seed value. The server device(s) 320 may also comprise a decryptor 316, similar to decryptor 116 discussed above, and may decrypt the encrypted private key using the cipher value.

Server device(s) 320 may also comprise a digital signature algorithm 318, which may be embodied in hardware or software in various implementations or a combination of hardware and software. Digital signature algorithm 318 may comprise any type and form of scheme for cryptographically signing data, such as the Rivest-Shamir-Adleman algorithm (RSA), digital signature algorithm (DSA), or any other type and form of suitable signature algorithm. Using the decrypted private key (shown as unshaded symbol X), the signer 318 may generate a signed version of the data or signature for the data or transaction. The signed data or transaction (shown as a starburst W symbol in FIG. 3) or the signature in some implementations may be transmitted back to the client device 302, for example for broadcast to a centralized or distributed ledger or other such use. In other implementations, the signed data or transaction may be broadcast to a centralized or distributed ledger by the server device(s) 230. The unencrypted private key (and the cipher value and/or user identifier in some implementations) may be deleted, discarded, or otherwise purged from memory of the server device(s) 320 after signing the transaction or data.

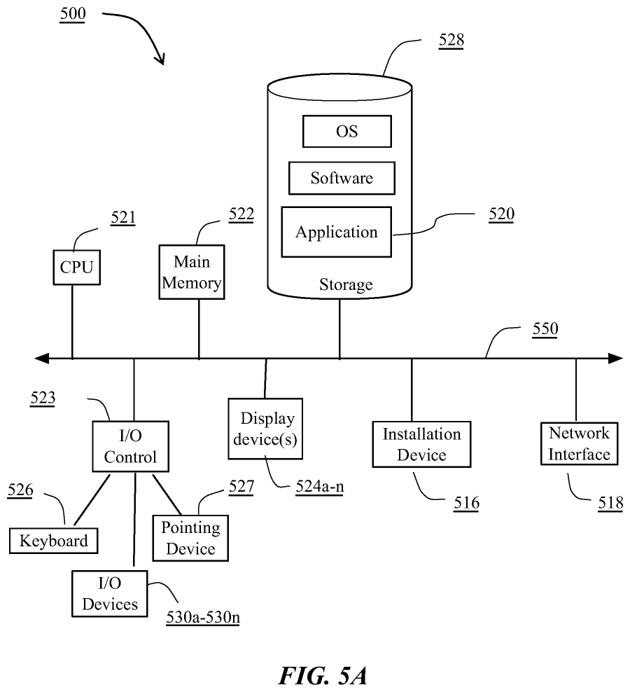

FIG. 4 is a flow chart of an implementation of a method of digitally signing data using a non-custodial key. At step 420, in some implementations, a first computing device, such as a server device or devices, may receive a public key from a second computing device such as a client computing device. In some implementations, the public key may be transmitted as part of a request to digitally sign a transaction or item of data.

At step 422, in some implementations, the first computing device may retrieve an encrypted private key and seed value using the public key. The encrypted private key and seed value may be retrieved from the same database or data structure, or different databases in different implementations.

At step 424, in some implementations, the first computing device may receive a user identifier from the second computing device. The user identifier may comprise a passphrase, password, biometric identifier, optical code, or any other type and form of identifier. The user identifier may be transmitted via any suitable means, and in many implementations, may be provided along with the public key at step 420 (e.g. as part of a request to sign the transaction or data).

At step 426, in some implementations, the first computing device may encipher the user identifier and the seed value. As discussed above, the first computing device may utilize any suitable symmetric encryption, such as AES-256 or DES or a combination of these or other algorithms, and may generate a cipher value.

At step 428, in some implementations, the first computing device may decrypt the encrypted private key using the cipher value. As discussed above, decrypting the private key may comprise using any suitable decryption algorithm, such as AES-256 or DES or a combination of these or other algorithms.

At step 430, in some implementations, the first computing device may receive data or a transaction to be digitally signed from the second computing device. In many implementations, the data or transaction may be transmitted at step 424 with the user identifier or step 420 with the public key (e.g. as part of the request to sign the transaction or data).

At step 432, in some implementations, the first computing device may generate a cryptographic signature using the unencrypted private key. Any suitable signature scheme may be used, such as RSA, DSA, or any similar digital signature algorithm.

At step 434 in some implementations, the first computing device may transmit the digital signature to the second computing device. In some implementations, the data or transaction may also be transmitted to the second computing device. The second computing device may then transmit the transaction or data and signature to another computing device or devices for recordation on a centralized or distributed ledger, or may otherwise use the signed data or transaction. In other implementations, the first computing device may transmit the signed transaction or data for recordation.

At step 436, in some implementations, the first computing device may discard or delete or otherwise purge the unencrypted private key from memory. The first computing device may, in some implementations, discard or delete the user identifier and/or cipher value.

Accordingly, the systems and methods discussed herein provide for non-custodial key generation and storage in which, other than for brief periods during key generation, when digitally signing data, or when decrypting encrypted data, the user's private key is not stored in an unencrypted form, either on the user's device or external or network storage. Instead, the private key is stored encrypted by a cipher that similarly relies on a secret that is not stored on either the user's device or any network location. As a result, the user need not be concerned about loss of their personal device or hardware key wallet, or that malicious attackers may access a third-party data store and obtain the unencrypted private key.

In a first aspect, the present disclosure is directed to a method for non-custodial cryptographic key storage. The method includes receiving, by a first computing device via an input device, an identifier of a user. The method also includes generating, by the first computing device, a seed value. The method also includes enciphering, by the first computing device, the identifier of the user and the seed value to generate a cipher value. The method also includes retrieving, by the first computing device, a private key of a cryptographic key pair. The method also includes encrypting, by the first computing device, the private key with the cipher value. The method also includes storing, by the first computing device, the encrypted private key and the seed value in association with a public key of the cryptographic key pair.

In some implementations, the identifier of the user comprises a user-generated key. In some implementations, the identifier of the user comprises a passphrase. In some implementations, the seed value comprises a random number or a pseudo-random number. In some implementations, enciphering the identifier of the user and the seed value further comprises concatenating the first identifier and the seed value. In some implementations, retrieving the private key further comprises generating, by the first computing device, the cryptographic key pair. In some implementations, storing the encrypted private key and the seed value further comprises storing the encrypted private key in a first database in association with the public key, and storing the seed value in a second database in association with the public key. In a further implementation, at least one of the first database and the second database is managed by a second computing device; and storing the encrypted private key and the seed value further comprises transmitting at least one of the encrypted private key and the seed value to the second computing device for storage.

In some implementations, the method includes discarding the private key after encrypting the private key with the cipher value. In some implementations, the private key is not stored. In some implementations, the identifier of the user is not stored.

In another aspect, the present disclosure is directed to a system for non-custodial cryptographic key storage. The system includes a first computing device comprising an input device and a processor configured to: receive, via the input device, an identifier of the user; generate a seed value; encipher the identifier of the user and the seed value to generate a cipher value; retrieve a private key of a cryptographic key pair; encrypt the private key with the cipher value; and store the encrypted private key and the seed value in association with a public key of the cryptographic key pair.

In another aspect, the present disclosure is directed to a method for non-custodial cryptographic key retrieval. The method includes retrieving, by a first computing device using a public key of a cryptographic key pair of a user, an encrypted private key of the cryptographic key pair. The method also includes retrieving, by the first computing device using the public key, a seed value. The method also includes receiving, by the first computing device, an identifier of the user. The method also includes enciphering, by the first computing device, the identifier of the user and the seed value to generate a cipher value. The method also includes decrypting, by the first computing device, the private key with the cipher value.

In some implementations, the identifier of the user comprises a user-generated key. In some implementations, the identifier of the user comprises a passphrase. In some implementations, the seed value comprises a random number or a pseudo-random number. In some implementations, retrieving the encrypted private key further comprises: transmitting, by the first computing device to a second computing device, the public key; and receiving, by the first computing device from the second computing device, the encrypted private key transmitted responsive to receipt of the public key. In some implementations, retrieving the seed value further comprises: transmitting, by the first computing device to a second computing device, the public key; and receiving, by the first computing device from the second computing device, the seed value transmitted responsive to receipt of the public key. In some implementations, the encrypted private key is stored in a first database, and wherein the seed value is stored in a second database. In some implementations, the method includes subsequently discarding the decrypted private key.

In another aspect, the present disclosure is directed to a method for digitally signing data using a non-custodial key. The method includes receiving, by a first computing device, an identifier of a user, a public key of a cryptographic key pair of the user, and data to be digitally signed. The method also includes retrieving, by the first computing device using the public key, an encrypted private key of the cryptographic key pair. The method also includes retrieving, by the first computing device using the public key, a seed value. The method also includes enciphering, by the first computing device, the identifier of the user and the seed value to generate a cipher value. The method also includes decrypting, by the first computing device, the private key with the cipher value. The method also includes generating, by the first computing device, a digital signature of the data using the decrypted private key.

In some implementations, the decrypted private key is discarded after generating the digital signature. In some implementations, the identifier of the user, the public key, and the data to be digitally signed are received from a second computing device; and the method includes transmitting the digital signature of the data to the second computing device. In some implementations, the identifier of the user comprises a user-generated key. In some implementations, the identifier of the user comprises a passphrase. In some implementations, the seed value comprises a random number or a pseudo-random number. In some implementations, the encrypted private key is stored in a first database, and wherein the seed value is stored in a second database.

In another aspect, the present disclosure is directed to a system for digitally signing data using a non-custodial key. The system includes a first computing device comprising a processor configured to: receive an identifier of a user, a public key of a cryptographic key pair of the user, and data to be digitally signed; retrieve, using the public key, an encrypted private key of the cryptographic key pair; retrieve, using the public key, a seed value; encipher the identifier of the user and the seed value to generate a cipher value; decrypt the private key with the cipher value; and generate a digital signature of the data using the decrypted private key.

### B. Computing Environment

Having discussed specific embodiments of the present solution, it may be helpful to describe aspects of the operating environment as well as associated system components (e.g., hardware elements) in connection with the methods and systems described herein.

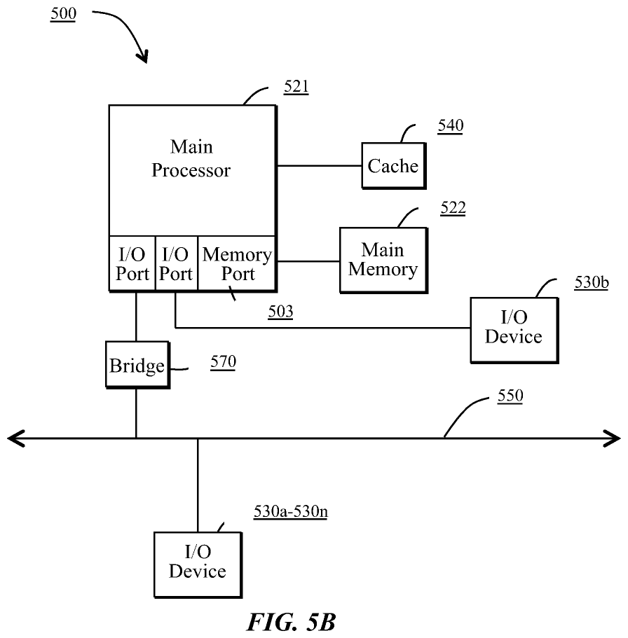

The systems discussed herein may be deployed as and/or executed on any type and form of computing device, such as a computer, network device or appliance capable of communicating on any type and form of network and performing the operations described herein. FIGS. 5A and 5B depict block diagrams of a computing device 500 useful for practicing an embodiment of the wireless communication devices 502 or the access point 506. As shown in FIGS. 5A and 5B, each computing device 500 includes a central processing unit 521, and a main memory unit 522. As shown in FIG. 5A, a computing device 500 may include a storage device 528, an installation device 516, a network interface 518, an I/O controller 523, display devices 524a-524n, a keyboard 526 and a pointing device 527, such as a mouse. The storage device 528 may include, without limitation, an operating system and/or software. As shown in FIG. 5B, each computing device 500 may also include additional optional elements, such as a memory port 503, a bridge 570, one or more input/output devices 530a-530n (generally referred to using reference numeral 530), and a cache memory 540 in communication with the central processing unit 521.

The central processing unit 521 is any logic circuitry that responds to and processes instructions fetched from the main memory unit 522. In many embodiments, the central processing unit 521 is provided by a microprocessor unit, such as: those manufactured by Intel Corporation of Mountain View, California; those manufactured by International Business Machines of White Plains, New York; or those manufactured by Advanced Micro Devices of Sunnyvale, California. The computing device 500 may be based on any of these processors, or any other processor capable of operating as described herein.

Main memory unit 522 may be one or more memory chips capable of storing data and allowing any storage location to be directly accessed by the microprocessor 521, such as any type or variant of Static random access memory (SRAM), Dynamic random access memory (DRAM), Ferroelectric RAM (FRAM), NAND Flash, NOR Flash and Solid State Drives (SSD). The main memory 522 may be based on any of the above described memory chips, or any other available memory chips capable of operating as described herein. In the embodiment shown in FIG. 5A, the processor 521 communicates with main memory 522 via a system bus 550 (described in more detail below). FIG. 5B depicts an embodiment of a computing device 500 in which the processor communicates directly with main memory 522 via a memory port 503. For example, in FIG. 5B the main memory 522 may be DRDRAM.

FIG. 5B depicts an embodiment in which the main processor 521 communicates directly with cache memory 540 via a secondary bus, sometimes referred to as a backside bus. In other embodiments, the main processor 521 communicates with cache memory 540 using the system bus 550. Cache memory 540 typically has a faster response time than main memory 522 and is provided by, for example, SRAM, BSRAM, or EDRAM. In the embodiment shown in FIG. 5B, the processor 521 communicates with various I/O devices 530 via a local system bus 550. Various buses may be used to connect the central processing unit 521 to any of the I/O devices 530, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 524, the processor 521 may use an Advanced Graphics Port (AGP) to communicate with the display 524. FIG. 5B depicts an embodiment of a computer 500 in which the main processor 521 may communicate directly with I/O device 530b, for example via HYPERTRANSPORT, RAPIDIO, or INFINIBAND communications technology. FIG. 5B also depicts an embodiment in which local busses and direct communication are mixed: the processor 521 communicates with I/O device 530a using a local interconnect bus while communicating with I/O device 530b directly.

A wide variety of I/O devices 530a-530n may be present in the computing device 500. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 523 as shown in FIG. 5A. The I/O controller may control one or more I/O devices such as a keyboard 526 and a pointing device 527, e.g., a mouse or optical pen. Furthermore, an I/O device may also provide storage and/or an installation medium 516 for the computing device 500. In still other embodiments, the computing device 500 may provide USB connections (not shown) to receive handheld USB storage devices such as the USB Flash Drive line of devices manufactured by Twintech Industry, Inc. of Los Alamitos, California.

Referring again to FIG. 5A, the computing device 500 may support any suitable installation device 516, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 500 may further include a storage device, such as one or more hard disk drives or redundant arrays of independent disks, for storing an operating system and other related software, and for storing application software programs such as any program or software 520 for implementing (e.g., configured and/or designed for) the systems and methods described herein. Optionally, any of the installation devices 516 could also be used as the storage device. Additionally, the operating system and the software can be run from a bootable medium.

Furthermore, the computing device 500 may include a network interface 518 to interface to the network 504 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 500 communicates with other computing devices 500′ via any type and/or form of gateway or tunneling protocol such as Secure Socket Layer (SSL) or Transport Layer Security (TLS). The network interface 518 may include a built-in network adapter, network interface card, PCMCIA network card, card bus network adapter, wireless network adapter, USB network adapter, modem or any other device suitable for interfacing the computing device 500 to any type of network capable of communication and performing the operations described herein.

In some embodiments, the computing device 500 may include or be connected to one or more display devices 524a-524n. As such, any of the I/O devices 530a-530n and/or the I/O controller 523 may include any type and/or form of suitable hardware, software, or combination of hardware and software to support, enable or provide for the connection and use of the display device(s) 524a-524n by the computing device 500. For example, the computing device 500 may include any type and/or form of video adapter, video card, driver, and/or library to interface, communicate, connect or otherwise use the display device(s) 524a-524n. In one embodiment, a video adapter may include multiple connectors to interface to the display device(s) 524a-524n. In other embodiments, the computing device 500 may include multiple video adapters, with each video adapter connected to the display device(s) 524a-524n. In some embodiments, any portion of the operating system of the computing device 500 may be configured for using multiple displays 524a-524n. One ordinarily skilled in the art will recognize and appreciate the various ways and embodiments that a computing device 500 may be configured to have one or more display devices 524a-524n.

In further embodiments, an I/O device 530 may be a bridge between the system bus 550 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 500 of the sort depicted in FIGS. 5A and 5B may operate under the control of an operating system, which control scheduling of tasks and access to system resources. The computing device 500 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Washington; MAC OS, produced by Apple Computer of Cupertino, California; WebOS, produced by Research In Motion (RIM); OS/2, produced by International Business Machines of Armonk, New York; and Linux, a freely-available operating system distributed by Caldera Corp. of Salt Lake City, Utah, or any type and/or form of a Unix operating system, among others.

The computer system 500 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 500 has sufficient processor power and memory capacity to perform the operations described herein.

In some embodiments, the computing device 500 may have different processors, operating systems, and input devices consistent with the device. For example, in one embodiment, the computing device 500 is a smart phone, mobile device, tablet or personal digital assistant. In still other embodiments, the computing device 500 is an Android-based mobile device, an iPhone smart phone manufactured by Apple Computer of Cupertino, California, or a Blackberry or WebOS-based handheld device or smart phone, such as the devices manufactured by Research In Motion Limited. Moreover, the computing device 500 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users”, such “users” may refer to user-associated devices or stations (STAs), for example, consistent with the terms “user” and “multi-user” typically used in the context of a multi-user multiple-input and multiple-output (MU-MIMO) environment.

Although examples of communications systems described above may include devices and APs operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C #, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A method for non-custodial cryptographic key storage, comprising:
receiving, by a first computing device via an input device, an identifier of a user;
generating, by the first computing device, a seed value;
enciphering, by the first computing device, the identifier of the user and the seed value to generate a cipher value;
retrieving, by the first computing device, a private key of a cryptographic key pair;
encrypting, by the first computing device, the private key with the cipher value; and
storing, by the first computing device, the encrypted private key and the seed value in association with a public key of the cryptographic key pair.

2. The method of claim 1, wherein the identifier of the user comprises a user-generated key.

3. The method of claim 1, wherein the identifier of the user comprises a passphrase.

4. The method of claim 1, wherein the seed value comprises a random number or a pseudo-random number.

5. The method of claim 1, wherein enciphering the identifier of the user and the seed value further comprises concatenating the first identifier and the seed value.

6. The method of claim 1, wherein retrieving the private key further comprises generating, by the first computing device, the cryptographic key pair.

7. The method of claim 1, wherein storing the encrypted private key and the seed value further comprises storing the encrypted private key in a first database in association with the public key, and storing the seed value in a second database in association with the public key.

8. The method of claim 7, wherein at least one of the first database and the second database is managed by a second computing device; and wherein storing the encrypted private key and the seed value further comprises transmitting at least one of the encrypted private key and the seed value to the second computing device for storage.

9. The method of claim 1, further comprising discarding the private key after encrypting the private key with the cipher value.

10. The method of claim 1, wherein the private key is not stored.

11. The method of claim 1, wherein the identifier of the user is not stored.

12. A system for non-custodial cryptographic key storage, comprising:
a first computing device comprising an input device and a processor configured to:
receive, via the input device, an identifier of the user,
generate a seed value,
encipher the identifier of the user and the seed value to generate a cipher value,
retrieve a private key of a cryptographic key pair,
encrypt the private key with the cipher value, and
store the encrypted private key and the seed value in association with a public key of the cryptographic key pair.

13. A method for non-custodial cryptographic key retrieval, comprising:
retrieving, by a first computing device using a public key of a cryptographic key pair of a user, an encrypted private key of the cryptographic key pair;
retrieving, by the first computing device using the public key, a seed value;
receiving, by the first computing device, an identifier of the user;
enciphering, by the first computing device, the identifier of the user and the seed value to generate a cipher value; and
decrypting, by the first computing device, the private key with the cipher value.

14. The method of claim 13, wherein the identifier of the user comprises a user-generated key.

15. The method of claim 13, wherein the identifier of the user comprises a passphrase.

16. The method of claim 13, wherein the seed value comprises a random number or a pseudo-random number.

17. The method of claim 13, wherein retrieving the encrypted private key further comprises:
transmitting, by the first computing device to a second computing device, the public key; and
receiving, by the first computing device from the second computing device, the encrypted private key transmitted responsive to receipt of the public key.

18. The method of claim 13, wherein retrieving the seed value further comprises:
transmitting, by the first computing device to a second computing device, the public key; and
receiving, by the first computing device from the second computing device, the seed value transmitted responsive to receipt of the public key.

19. The method of claim 13, wherein the encrypted private key is stored in a first database, and wherein the seed value is stored in a second database.

20. The method of claim 13, further comprising subsequently discarding the decrypted private key.

21. A method for digitally signing data using a non-custodial key, comprising:
receiving, by a first computing device, an identifier of a user, a public key of a cryptographic key pair of the user, and data to be digitally signed;
retrieving, by the first computing device using the public key, an encrypted private key of the cryptographic key pair;
retrieving, by the first computing device using the public key, a seed value;
enciphering, by the first computing device, the identifier of the user and the seed value to generate a cipher value;
decrypting, by the first computing device, the private key with the cipher value; and
generating, by the first computing device, a digital signature of the data using the decrypted private key.

22. The method of claim 21, wherein the decrypted private key is discarded after generating the digital signature.

23. The method of claim 21, wherein the identifier of the user, the public key, and the data to be digitally signed are received from a second computing device; and further comprising transmitting the digital signature of the data to the second computing device.

24. The method of claim 21, wherein the identifier of the user comprises a user-generated key.

25. The method of claim 21, wherein the identifier of the user comprises a passphrase.

26. The method of claim 21, wherein the seed value comprises a random number or a pseudo-random number.

27. The method of claim 21, wherein the encrypted private key is stored in a first database, and wherein the seed value is stored in a second database.

28. A system for digitally signing data using a non-custodial key, comprising:
a first computing device comprising a processor configured to:
receive an identifier of a user, a public key of a cryptographic key pair of the user, and data to be digitally signed,
retrieve, using the public key, an encrypted private key of the cryptographic key pair,
retrieve, using the public key, a seed value,
encipher the identifier of the user and the seed value to generate a cipher value,
decrypt the private key with the cipher value, and
generate a digital signature of the data using the decrypted private key.
